(19) United States
(12) Patent Application Publication
(10) Pub. No.: US 2024/0057034 A1
(43) Pub. Date: Feb. 15, 2024

(54) METHOD AND SYSTEM FOR GROUPING OF PAGING IN WIRELESS NETWORK

(71) Applicant: Samsung Electronics Co., Ltd., Suwon-si, Gyeonggi-do (KR)

(72) Inventors: Vinay Kumar SHRIVASTAVA, Bangalore (IN); Anil AGIWAL, Suwon-si (KR)

(21) Appl. No.: 18/268,833

(22) PCT Filed: Dec. 21, 2021
(86) PCT No.: PCT/KR2021/019514

§ 371 Date: Jun. 21, 2023

(30) Foreign Application Priority Data
Dec. 21, 2020 (IN) 202041055608
Nov. 25, 2021 (IN) 2020 41055608

(51) Int. Cl. H04W 68/02

(52) U.S. Cl. CPC H04W 68/02

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. Embodiments herein disclose a method for grouping of paging for multiple UEs in a paging occasion in a wireless network (1000) by an AMF entity (300). The method includes determining paging sub-group information to be allocated to a UE (100) based on characteristics of the UE (100). Further, the method includes allocating the paging sub-group information to the UE (100) for paging. Further, the method includes sending the allocated paging sub-group information to the UE (100) and a gNodeb (200). The method can be used to provide a paging reduction feature to improve a power consumption performance for the UE (100) in the wireless network (1000). The proposed method can be used to reduce a false alarm occurrence for the UE (100), so as to provide efficient paging reception approach for the UE (100), when the UE (100) is in an idle mode/inactive mode.

### TECHNICAL FIELD

The present disclosure relates to a wireless network and in particular, relates to a method and a system for grouping of paging in the wireless network. This application is based on and derives the benefit of Indian Provisional Application 202041055608 filed on 21^{st} Dec., 2020, the contents of which are incorporated herein by reference.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### DISCLOSURE OF INVENTION

### Technical Problem

In general, a wireless network transmits paging messages to a group of a User Equipment (UEs) to indicate arrival of downlink contents (e.g. call, data, updated information etc.) for the UE. When the UE is in an idle/inactive mode, the UE monitors the paging messages and initiates appropriate procedures (e.g. connection setup procedure, reading/updating broadcast information etc.).

In an example, when a New Radio or fifth generation (5G) UE (i.e., NR UE) is in the idle mode/inactive mode, the 5G UE calculates its Paging Occasion (PO) and Paging Frame (PF) based on its UE ID and N, where UE ID: 5G-S-TMSI mod 1024, and N: number of total paging frames in a Discontinuous Reception (DRX) cycle T of the UE. Based on the PO and PF, the 5G UE monitors a PDCCH (Physical Downlink Control Channel) to read a paging DCI i.e. Downlink Control Information (DCI format 1_0 with a Cyclic Redundancy Checksum (CRC) scrambled by a P-RNTI (i.e. Paging Radio Network Terminal Identifier) and further reads the paging message. The 5G UE decides if the paging message is intended for it only after reading the actual paging message. All other UEs discard the paging message as a false alarm. This way, a group of UEs (paging group) reads PDCCH and further paging message based on respective UE_ID and N on the same PO and PF.

Further, reception of paging message in the idle mode/the inactive mode invokes the UE to come out of a sleep mode and increases its power consumption of the UE.

FIG. 1 is a sequence diagram illustrating grouping of paging in a wireless network, according to prior art. At S102, a gNodeb (200) sends a SIB1 (including paging Config) to the UE (100). The UE (100) receives the SIB1. At S104, the UE (100) performs the PO computation. At S106, the UE (100) receives the PDCCH (DCI_1.0) from the gNodeb (200). At S108, the UE (100) receives a Physical Downlink Shared Channel (PDSCH) (i.e., paging message) from the gNodeb (200). At S110, the UE (100) processes the paging message at a radio resource control (RRC) layer. At S112, the UE (100) determines the false paging is detected? (I.e. the false paging is determined when the paging message is not intended to the UE (100) as the UE identity in the paging message does not correspond to the UE (100)). If the false paging is not detected then, at S114, the UE (100) sends the paging response to the gNodeb (200). If the false paging is detected then, the method performs the operation S106. The conventional method takes the large paging false alarm detection time. This results in consuming the UE power in the idle mode/the inactive mode with respect to reception of the paging messages and associated procedures.

Thus, it is desired to address the above mentioned disadvantages or other shortcomings or at least provide a useful alternative.

### Solution to Problem

Accordingly, the embodiment herein is to disclose a method for grouping of paging for multiple UEs in a paging occasion in a wireless network. The paging sub-groups are formed based on either a Core Network (i.e. AMF entity) controlled sub-grouping or UE ID based sub-grouping (i.e. gNodeB managed). When the Core Network controlled sub-grouping method is not used, UE ID based sub-grouping method can be used, if supported by the UE and the gNodeB.

The core network controlled sub-grouping method includes determining, by an Access and Mobility Management Function (AMF) entity, paging sub-group information to be allocated to a UE based on at least one characteristics of the UE. Further, the method includes allocating, by the AMF entity, the paging sub-group information to the UE for paging. Further, the method includes sending, by the AMF entity, the allocated paging sub-group information to the UE and a gNodeb.

In an embodiment, allocating, by the AMF entity, the paging sub-group information to the UE includes sending a Non-Access Stratum (NAS) message comprising the paging sub-group information to be used by the UE.

In an embodiment, the paging sub-group information includes one of an indication to at least one paging sub-group identity (ID) to be used by the UE in a RRC idle state, an indication of at least one paging sub-group ID to be used by the UE in an RRC inactive state, an indication of at least one paging sub-group ID to be used by the UE in an RRC idle state and an RRC inactive state.

In an embodiment, determining, by the AMF entity, paging sub-group information to be allocated to the UE based on the at least one of the characteristics of the UE includes receiving, by the AMF entity, an assistance information from the UE, and determining, by the AMF entity, the paging sub-group information to be allocated to the UE based on the at least one of the characteristics of the UE and the assistance information received the UE. The assistance information comprises PCS and paging probability information.

In an embodiment, sending, by the AMF entity, the allocated paging sub-group information allocated to the UE and the gNodeb includes sending, by the AMF entity, a NAS signaling message comprising the allocated paging sub-group information allocated to the UE for paging to the UE and gNodeb.

In an embodiment, allocating, by the AMF entity, the paging sub-group information to the UE for paging includes sending, by the AMF entity, the sub-group information to the gNodeb associated with the UE and forwarding, by the gNodeb, the paging subgroup information to the UE for paging.

Accordingly, the embodiment herein is to disclose a method for grouping of paging for multiple UEs in a paging occasion in a wireless network. The UE ID based subgrouping method includes determining, by the gNodeb, paging sub-group identity to be allocated to a UE based on an identity of the UE and a total number of sub-groups associated with the UE identity based-sub-grouping in a cell. The UE identity is based on 5G-S-TMSI e.g. 5G-S-TMSI mod 1024, 5G-S-TMSI mod 8192 or in general, 5G-S-TMSI mod X, wherein X is (1024*Nps). The paging sub-group identity is determined by formulation as paging_sub_group ID=floor (UE_ID/(N*Ns)) mod Nps wherein Nps—Number of paging-sub-groups as configured by network in the cell. Further, the method includes allocating, by the gNodeb, the paging sub-group identity to the UE for paging.

In an embodiment, the method includes determining, by the gNodeb, the total number of paging sub-groups for the UE identity based-sub-grouping for each cell. The total number of sub-groups for the UE identity based-sub-grouping is different in different cells. Further, the method includes broadcasting, by the gNodeb, the total number of sub-groups for the UE identity based-sub-grouping in the paging sub-group configuration in a system information to the UE. If number of paging sub-groups is absent or number of paging sub-group is 0 or number of paging sub-group is 1, it is determined that gNB does not support paging-sub-group based approach. Further, the number of paging sub-groups can be paging sub-groups per PO.

In an embodiment, the method includes determining, by the gNodeb, an offset for paging early indication (PEI) to indicate a presence or absence of paging for the UE's paging sub-group in a paging occasion. Further, the method includes sending, by the gNodeb, the offset in the PEI configuration along with the paging sub-group configuration to the UE.

In an embodiment, the method includes determining, by the gNodeb, the paging subgroup identity to be allocated to the UE comprises determining a paging sub-group ID to be used by the UE based on the formulation based on identity of the UE. The formulation of paging sub-group identitity is given as paging_sub_group ID=floor (UE_ID/(N*Ns)) mod Nps wherein Nps−Number of paging-sub-groups as configured by network in the cell.

In an alternative embodiment, allocating, by the gNodeb, the paging sub-group information to the UE includes sending a RRC message comprising a legacy paging confirmation and the paging sub-group information to the UE, wherein the RRC message comprises one of a RRC release, a RRC release with redirection, a RRC release with suspend configuration message.

Accordingly, the embodiment herein is to disclose a method for grouping of paging for multiple UEs in a paging occasion in a wireless network. The method includes receiving, by the UE, a SIB message from a gNodeb. Further, the method includes determining, by the UE, whether the SIB message comprises paging sub-group configuration having at least one of number of paging sub-groups and an offset for paging early indication (PEI) to indicate a presence or absence of paging for the UE's paging sub-group in a paging occasion. Further, the method includes performing, by the UE, one of: in response to determining that the SIB message comprises the paging subgroup configuration having the at least one of number of paging sub-groups, determine the paging sub-group identity based on formulation based on UE identity, and performing the paging reception based on the determined paging sub-group identity. Paging sub-group identity is determined by formulation as paging_sub_group ID floor (UE_ID/(N*Ns)) mod Nps wherein Nps−Number of paging-sub-groups as configured by network in the cell.

In an embodiment, performing the paging based on the determined paging sub-group identity includes receiving, by the UE, an indication indicating support for the paging sub-group identity from a cell on which the UE is currently camped, wherein the indication comprises paging sub-group related parameter; determining, by the UE, a Paging Occasion (PO) based on the offset; receiving, by the UE, at least one of a paging DCI, a paging early indication (PEI), and a reference signal to indicate a presence or absence of the paging for UE's paging sub-group in the paging occasion from the AMF entity or the gNodeb, detecting, by the UE, whether presence or absence of paging for the sub-group identity in at least one of the paging DCI, the PEI, and the reference signal, and performing, by the UE, one of: performing the paging reception in response to detecting the presence of the paging sub-group identity in at least one of a paging DCI, a paging early indication and a reference signal; and configuring the UE in a sleep mode in response to detecting absence of the paging subgroup identity in at least one of a paging DCI, a paging early indication and a reference signal.

In an embodiment, the paging DCI includes the usage of at least one reserved bit indicating a presence or an absence of the at least one paging-sub-group identity used by the UE (100) in at least one of idle state and inactive state.

In an embodiment, the PEI comprises at least one bit or a bitmap indicating a presence or an absence of the at least one paging-sub-group identity used by the UE (100) in at least one of idle state and inactive state.

In an embodiment, the particular signal is one of a Secondary Synchronization Signal (SSS), a channel state information reference signal (CSIRS), a Tracking Reference Signal (TRS) and Demodulation Reference Signal (DMRS) indicating a presence or an absence of the at least one paging-sub-group identity used by the UE (100) in at least one of idle state and inactive state.

Accordingly, the embodiment herein is to disclose an AMF entity for grouping of paging for multiple UEs in a paging occasion in a wireless network. The AMF entity includes a memory to store information about a gNodeb and a UE, a processor, and a paging grouping controller communicatively coupled to the memory and the process. The paging grouping controller is configured to determine paging sub-group information to be allocated to an UE based on at least one of the characteristics of the UE and allocate the paging sub-group information to the UE for paging. Further, the paging grouping controller is configured to send the allocated paging sub-group information allocated to the UE and gNodeb.

Accordingly, the embodiment herein is to disclose a gNodeb for grouping of paging for multiple UEs in a paging occasion in a wireless network. The gNodeb includes a memory to store information about an AMF entity and a UE, a processor, and a paging grouping controller communicatively coupled to the memory and the process. The paging grouping controller is configured to determine paging sub-group identity to be allocated to an UE based on an identity of the UE and a total number of sub-groups associated with the UE identity based-sub-grouping in a cell. The paging grouping controller is configured to allocate the paging sub-group identity to the UE for paging.

Accordingly, the embodiment herein is to disclose a UE for grouping of paging in a wireless network. The UE includes a memory to store information about gNodeb and an AMF entity, a processor, and a paging grouping controller communicatively coupled to the memory and the processer. The paging grouping controller is configured to receive a NAS signaling message form an AMF or a SIB message from a gNodeb. Paging grouping controller is configured to receive a paging sub-group identity in the NAS message, when received from AMF entity. The paging grouping controller is configured to determine whether the SIB message comprises paging sub-group configuration having at least one of number of paging sub-groups and a configuration for PEI having at least an offset parameter. The paging grouping controller is configured to perform one of in response to determining that the SIB message comprises the paging sub-group configuration having the at least one paging sub-group identity, configure the UE to consider the at least one paging sub-group identity determined from the formulation as UE sub-group identity.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

The principal object of the embodiments herein is to provide a method and system for grouping of paging in a wireless network.

Another object of the embodiments herein is to provide a paging reduction feature to reduce a power consumption for the UE in the wireless network. The proposed method can be used to reduce the false alarm occurrences for the UE. The method can be used to provide efficient paging reception approach for the UE, when the UE is in an idle mode/an inactive mode.

### BRIEF DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1 is a sequence diagram illustrating grouping of paging in a wireless network, according to prior art;

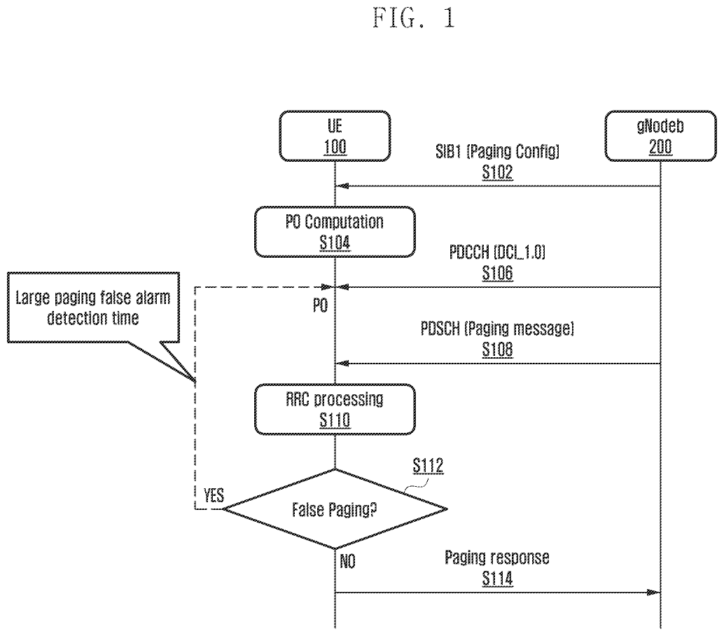

FIG. 2 is an overview of a wireless network for grouping of paging, according to an embodiment as disclosed herein;

FIG. 3 shows various hardware components of a UE, according to an embodiment as disclosed herein;

FIG. 4 shows various hardware components of a gNodeb, according to an embodiment as disclosed herein;

FIG. 5 shows various hardware components of a AMF entity, according to an embodiment as disclosed herein;

FIG. 6 is a flow chart illustrating a method, implemented by the AMF entity, for grouping of paging for multiple UEs in a paging occasion in the wireless network, according to an embodiment as disclosed herein;

FIG. 7 is a flow chart illustrating a method, implemented by the gNodeb, for grouping of paging for multiple UEs in a paging occasion in the wireless network, according to an embodiment as disclosed herein;

FIG. 8A is a flow chart illustrating a method, implemented by the UE, for grouping of paging for multiple UEs in a paging occasion in the wireless network, according to an embodiment as disclosed herein;

FIG. 8B is a flow chart illustrating a method, implemented by the UE, for grouping of paging for multiple UEs in a paging occasion in the wireless network, according to an embodiment as disclosed herein;

FIG. 9 is a sequence diagram illustrating a method for grouping of paging for multiple UEs in a paging occasion in the wireless network based on a UE ID based paging sub-group, according to an embodiment as disclosed herein;

FIG. 10 is a sequence diagram illustrating a method for grouping of paging for multiple UEs in a paging occasion in the wireless network based on a NAS signaling for assistance information, according to an embodiment as disclosed herein;

FIG. 11 is a sequence diagram illustrating a method for grouping of paging for multiple UEs in a paging occasion in the wireless network without any assistance information from the UE, according to an embodiment as disclosed herein; and

FIG. 12 is a sequence diagram illustrating a method for grouping of paging for multiple UEs in a paging occasion in the wireless network based on a RRC signaling based assistance information, according to an embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for grouping of paging for multiple UEs in a paging occasion in a wireless network. The paging sub-groups are formed based on either Core Network (i.e. AMF entity) controlled sub-grouping or UE ID based sub-grouping (i.e. gNodeB managed). When the core network controlled sub-grouping method is not used, UE ID based sub-grouping method can be used, if supported by the UE and the gNodeB.

The core network (i.e. AMF) controlled sub-grouping method includes determining, by an AMF entity, paging sub-group information to be allocated to a UE based on at least one of the characteristics of the UE. Further, the method includes allocating, by the AMF entity, the paging sub-group information to the UE for paging. Further, the method includes sending, by the AMF entity, the allocated paging sub-group information to the UE and a gNodeb.

Unlike conventional methods, the proposed method can be used to provide a paging reduction feature to reduce a power consumption for the UE in the wireless network. The proposed method can be used to reduce the false alarm occurrences for the UEs. The method can be used to provide efficient paging reception approach for the UE, when the UE is in an idle mode or an inactive mode.

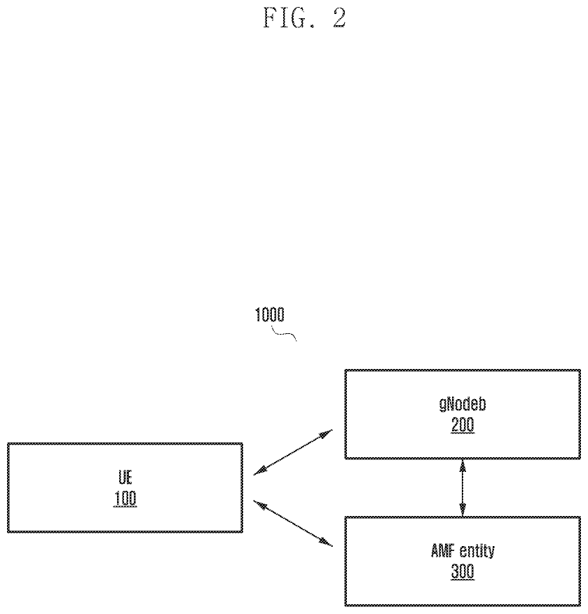

Referring now to the drawings and more particularly to FIGS. 2 through 12, where similar reference characters denote corresponding features consistently throughout the figures, there are shown preferred embodiments.

FIG. 2 is an overview of a wireless network (1000) for grouping of paging, according to an embodiment as disclosed herein. In an embodiment, the wireless network (1000) includes a UE (100), a gNodeB (200) and an AMF entity (300). The wireless network (1000) can be, for example, but not limited to a 5G network, a 6G network and an O-RAN network. The UE (100) can be, for example, but not limited to a laptop, a desktop computer, a notebook, a relay device, a Device-to-Device (D2D) device, a vehicle to everything (V2X) device, a smartphone, a tablet, an immersive device, a connected car, a television with communication facility and an internet of things (IoT) device.

In an embodiment, the AMF entity (300) is configured to determine a paging subgroup information to be allocated to the UE (100) based on at least one of the characteristics of the UE (100). The paging sub-group information includes an indication to a paging sub-group ID to be used by the UE (100) in a RRC idle state, an indication of the paging sub-group ID to be used by the UE (100) in an RRC inactive state, an indication of the paging sub-group ID to be used by the UE (100) in an RRC idle state and an RRC inactive state. In an embodiment, the AMF entity (300) is configured to receive an assistance information from the UE (100). The assistance information includes a Power consumption sensitivity (PCS) or power consumption profile and a paging probability information. Further, the AMF entity (300) is configured to determine the paging sub-group information to be allocated to the UE (100) based on the at least one of the characteristics of the UE (100) and the assistance information received the UE (100).

Further, the AMF entity (300) is configured to allocate the paging sub-group information to the UE (100) for paging. In an embodiment, the AMF entity (300) is configured to send a NAS message including the paging sub-group information to the UE (100). In another embodiment, the AMF entity (300) is configured to send the subgroup information to the gNodeb (200) associated with the UE (100) and allocate the paging sub-group information to the UE (100) for paging.

The AMF entity (300) is configured to send the allocated paging sub-group information to the UE (100) and the gNodeb (200). Further, the AMF entity (300) is configured to send a NAS signalling message comprising the allocated paging subgroup information carrying allocated paging sub-group identity to the UE (100) and the gNodeb (200).

Further, the UE (100) is configured to receive the NAS message from the AMF entity (300) carrying the allocated paging sub-group identity (Core Network controlled subgrouping method) or RRC (i.e. SIB) message from the gNodeb (200) (UE ID based sub-grouping). Further, the UE (100) is configured to determine whether the SIB message includes the paging sub-group configuration having the number of paging sub-groups or the PEI configuration including the offset for the PEI. The paging DCI includes a reserved bit indicate the wireless network (1000) configured or provided the paging-sub-group identity.

If the SIB message includes the paging sub-group configuration having the number of paging sub-groups then, the UE (100) determines the paging sub-group identity based on formulation based on UE identity. The UE identity is based on 5G-S-TMSI e.g. 5G-S-TMSI mod 1024, 5G-S-TMSI mod 8192 or in general, 5G-S-TMSI mod X, wherein X is (1024*Nps). Paging sub-group identity is given as paging_sub_group ID=floor (UE_ID/(N*Ns)) mod Nps, Where Nps−Number of paging-sub-groups as configured by network for the cell.

Further, the UE (100) is configured to determine the PEI based on the offset. Further, the UE (100) is configured to receive an indication indicating support for the paging sub-group identity from the cell on which the UE (100) is currently camped, where the indication includes the paging sub-group related parameter e.g. number of paging subgroups for paging occasion. Based on receiving, the UE (100) is configured to receive at least one of the paging DCI, a PEI, and a reference signal to indicate a presence or absence of the paging for the UE's paging sub-group in the paging occasion from the AMF entity (300) or the gNodeb (200). The reference signal can be, for example, but not limited to a SSS, a CSIRS, a TRS and DMRS to indicate a presence or absence of the paging sub-group identity to be used by the UE (100) in the idle state and the inactive state. The PEI includes a bit or a bitmap to indicate the presence or absence of paging-sub-group identity to be used by the UE (100) in the idle state and the inactive state.

Further, the UE (100) is configured to detect whether presence or absence of the subgroup identity in the at least one of the paging DCI, the PEI, and the reference signal. In response to detecting the presence of the paging sub-group identity in the paging DCI and the paging early indication, the UE (100) is configured to perform the paging reception using the paging sub-group identity. In another embodiment, the UE (100) configures the UE (100) itself in a sleep mode in response to detecting absence of the paging sub-group identity in at least one of a paging DCI, a a paging early indication and a reference signal.

Further, the gNodeb (200) is configured to determine paging sub-group information to be allocated to the UE (100) based on the identity of the UE (100) and the total number of sub-groups associated with the UE identity based-sub-grouping in the cell. Further, the gNodeb (200) is configured to allocate the paging sub-group information to the UE (100) for paging. The UE Identity is based on 5G-S-TMSI e.g. 5G-S-TMSI mod 1024, 5G-S-TMSI mod 8192 or in general, 5G-S-TMSI mod X, wherein X is (1024*Nps). The Paging sub-group identity is given as paging_sub_group ID=floor (UE_ID/(N*Ns)) mod Nps, Where Nps−Number of paging-sub-groups as configured by network for the cell. In an embodiment, the paging sub-group configuration is provided to the UE (100) by sending the SIB message comprising the number of paging sub-groups and PEI configuration to the UE (100).

Further, the gNodeb (200) is configured to determine the total number of sub-groups for the UE identity based-sub-grouping for each cell, wherein total number of subgroups for the UE identity based-sub-grouping can be different in different cells. The gNodeb (200) is configured to broadcast the total number of sub-groups in a system information to the UE (100).

Further, the gNodeb (200) is configured to determine an offset for PEI to indicate a presence or absence of a paging for UE's sub-group identity and send the offset in PEI configuration along with the paging sub-group configuration to the UE (100).

In an example, for the 5^{th} generation (also referred as NR or New Radio) wireless network, the UE (100) may use Discontinuous Reception (DRX) in the RRC_IDLE state and the RRC_INACTIVE state in order to reduce power consumption. In the RRC_IDLE/RRC_INACTIVE state, the UE (100) wake ups at regular intervals (i.e. every DRX cycle) for short periods to receive paging, to receive SI (system Information) update notification and to receive emergency notifications. The paging message is transmitted using physical downlink shared channel (PDSCH). A Physical downlink common control channel (PDCCH) is addressed to P-RNTI if there is a paging message in PDSCH. A P-RNTI is common for all UEs. The UE identity (i.e. STMSI for RRC_IDLE UE or I-RNTI for RRC_INACTIVE UE) is included in the paging message to indicate paging for a specific UE. The paging message may include multiple UE identities to page multiple UEs.

The paging message is broadcasted (i.e. PDCCH is masked with the P-RNTI) over a data channel (i.e. PDSCH). The SI update and the emergency notifications are included in the DCI and the PDCCH carrying this DCI is addressed to the P-RNTI. In the RRC idle/inactive mode, the UE (100) monitors one paging occasion (PO) every DRX cycle. In the RRC idle/inactive mode, the UE (100) monitors the PO in an initial DL BWP. In the Radio Resource Control (RRC) connected state, the UE (100) monitors one or more POs to receive the SI update notification and to receive emergency notifications. The UE (100) can monitor any PO in the paging DRX cycle and monitors the PO in the SI modification period. In the RRC connected mode, the UE (100) monitors the PO in its active DL BWP. The PO is a set of ‘S’ PDCCH monitoring occasions for paging, where ‘S’ is the number of transmitted SSBs (i.e. the Synchronization Signal and PBCH block (SSB) consists of primary and secondary synchronization signals (PSS, SSS) and PBCH) in the cell. The UE (100) first determines the paging frame (PF) and then determines the PO with respect to the determined PF. One PF is a radio frame (10 ms).

1. The PF for the UE (100) is the radio frame with system frame number ‘SFN’ which satisfies the equation (SFN+PF_offset) mod T=(T div N)*(UE_ID mod N).

2. Index (is), indicating the index of the PO is determined by is =floor (UE_ID/N) mod Ns.

3. T is DRX cycle of the UE (100).

a) In RRC_INACTIVE state, T is determined by the shortest of the UE specific DRX value configured by the RRC, the UE specific DRX value configured by the NAS, and a default DRX value broadcast in system information.

b) In RRC_IDLE state, T is determined by the shortest of UE specific DRX value configured by the NAS, and a default DRX value broadcast in system information. If the UE specific DRX is not configured by upper layers (i.e. NAS), the default value is applied.

4. N: number of total paging frames in T.

5. Ns: number of paging occasions for a PF.

6. PF_offset: offset used for PF determination.

7. UE_ID: 5G-S-TMSI mod 1024.

8. Parameters Ns, n andPagingFrameOffset, and the length of default DRX Cycle are signaled in SIB1. The values of N and PF_offset are derived from the parameter nAndPagingFrameOffset signaled by the gNB (200). If the UE (100) has no 5G-S-TMSI, for instance when the UE (100) has not yet registered onto the wireless network (1000), the UE (100) shall use as default identity UE_ID=0 in the PF and i_s formulas above.

The UE (100), in the idle/inactive mode, calculates its Paging Occasion (PO) and Paging Frame (PF) every DRX cycle. Based on the PO and PF, the UE (100) monitors the PDCCH to read paging DCI (DCI format 1_0 with CRC scrambled by P-RNTI) and further reads the paging message. The UE (100) decides if the paging message is intended for it only after reading the actual paging message. The UE(s) (100) whose paging identity is included in paging message processes the paging message. All other UEs discard the paging message as a False Alarm. This way, a group of UEs (paging group) reads PDCCH and further paging message based on respective UE_ID and N on the same PO and PF.

Paging-sub-group indication/allocation by the network (1000): In an embodiment, the network (1000) provides/signals information about the paging-sub-group (can also be referred as paging group) to the UE (100) in the RRC release/RRC release with redirection/RRC release with suspend configuration message.

In an embodiment, information about the paging sub-group comprises of one or more paging sub-group identities. In another embodiment, information about the paging subgroup comprises of indication to use paging sub-group. In another embodiment, information about the paging sub-group indication includes at least one of indication to use paging sub-group in RRC IDLE, indication to use paging sub-group in RRC_INACTIVE, indication to use paging sub-group in RRC IDLE and RRC INACTIVE wherein the UE (100) will use paging sub-group for receiving paging in indicated RRC state.

If the UE (100) receives the paging sub-group information in the RRC release message, the UE (100) receives the paging according to received paging sub-group information.

In an example, example of the reception of the RRCRelease by the UE (100) is provided below:

1>if the RRCRelease includes suspendConfig:
2>apply the received suspendConfig;
2>remove all the entries within VarConditionalReconfig, if any;
2>for each measId, if the associated reportConfig has a reportType set to
condTriggerConfig:
.......(Omitted text)....
2>reset MAC and release the default MAC Cell Group configuration, if
any;
2>re-establish RLC entities for SRB1;
2>if the RRCRelease message with suspendConfig was received in
response to an RRCResumeRequest or an RRCResumeRequest1:
....(Omitted text)...
2>suspend all SRB(s) and DRB(s), except SRB0;
2>indicate PDCP suspend to lower layers of all DRBs;
2>if the t380 is included:
3>start timer T380, with the timer value set to t380;
2>if the RRCRelease message is including the waitTime:
3>start timer T302 with the value set to the waitTime;
3>inform upper layers that access barring is applicable for all access
categories except categories ′0′ and ′2′;
2>if T390 is running:
3>stop timer T390 for all access categories;
3>perform the actions as specified;
2>indicate the suspension of the RRC connection to upper layers;
2>enter RRC_INACTIVE and perform cell selection as specified in TS
38.304 [20];
2>if the RRCRelease message is including the paging-sub-group in
suspendConfig
3> Perform paging reception in RRC_INACTIVE with utilizing paging-
sub-group as received
1>else
2>perform the actions upon going to RRC_IDLE as specified, with the
release cause ′other′.
2>if the RRCRelease message is including the paging-sub-group
3>Perform paging reception in RRC_IDLE with utilizing paging-sub-
group as received

Example structure of the RRC release message carrying paging sub-group information is given below:

| | |
|---|---|
| RRCRelease-v17xy-IEs ::= | SEQUENCE { |

| | |
|---|---|
| Paging-sub-group | PagingSub-group |

| | | |
|---|---|---|
| nonCriticalExtension | SEQUENCE { } | OPTIONAL |

}

| | |
|---|---|
| RedirectedCarrierInfo ::= | CHOICE { |

| | |
|---|---|
| Nr | CarrierInfoNR, |
| eutra | RedirectedCarrierInfo-EUTRA, |

...

}

| | |
|---|---|
| RedirectedCarrierInfo-EUTRA ::= | SEQUENCE { |

| | |
|---|---|
| eutraFrequency | ARFCN-ValueEUTRA, |

| | |
|---|---|
| cnType | ENUMERATED {epc,fiveGC} |

| | |
|---|---|
| OPTIONAL | -- Need N |

}

| | |
|---|---|
| CarrierInfoNR ::= | SEQUENCE { |

| | |
|---|---|
| carrierFreq | ARFCN-ValueNR, |

| | |
|---|---|
| ssbSubcarrierSpacing | SubcarrierSpacing, |

| | |
|---|---|
| Paging-sub-group | Paging Sub-group |

| | |
|---|---|
| smtc | SSB-MTC |

| | |
|---|---|
| OPTIONAL, | -- Need S |

...

}

| | |
|---|---|
| SuspendConfig ::= | SEQUENCE { |

| | |
|---|---|
| fullI-RNTI | I-RNTI-Value, |

| | |
|---|---|
| shortI-RNTI | ShortI-RNTI-Value, |

| | |
|---|---|
| ran-PagingCycle | PagingCycle, |

| | |
|---|---|
| Paging-sub-group | PagingSub-group |

| | |
|---|---|
| ran-NotificationAreaInfo | RAN-NotificationAreaInfo |

| | |
|---|---|
| OPTIONAL, | -- Need M |

| | |
|---|---|
| t380 | PeriodicRNAU-TimerValue |

| | |
|---|---|
| OPTIONAL, | -- Need R |

| | |
|---|---|
| nextHopChainingCount | NextHopChainingCount, |

...

}

| | |
|---|---|
| PeriodicRNAU-TimerValue ::= | ENUMERATED { min5, min10, min20, min30, min60, min120, |

min360, min720}

| | |
|---|---|
| CellReselectionPriorities ::= | SEQUENCE { |

| | |
|---|---|
| freqPriorityListEUTRA | FreqPriorityListEUTRA |

| | |
|---|---|
| OPTIONAL, | -- Need M |

freqPriorityListNRFreqPriorityListNR

| | |
|---|---|
| OPTIONAL, | -- Need M |

| | |
|---|---|
| t320 | ENUMERATED {min5, min10, min20, min30, min60, |

| | |
|---|---|
| min120, min180, spare1} OPTIONAL, | -- Need R |

...

}

In an embodiment, if the RRC release message includes the paging sub-group identity and if the camped cell supports the paging sub-groups (camped cell may indicate its support for paging sub-group by including paging sub-group related parameter e.g. number of sub-groups or indication supporting paging sub-group feature), the UE (100) considers the received paging sub-group identity as its paging sub-group identity and the UE (100) will check for this identity in the paging DCI and/or paging early indication. Otherwise, the UE (100) considers that paging sub-group is not configured.

In another embodiment, if the RRC release message does not include the paging subgroup identity and if the camped cell supports paging sub-groups (camped cell may indicate its support for paging sub-group by including paging sub-group related parameter e.g. number of sub-groups or indication supporting paging sub-group feature), the UE (100) determines its paging sub-group identity based on its UE ID (or based on paging probability or power consumption profile or based on UE ID/paging probability/power consumption profile/preferred network or RAN slice as indicated by the network (1000) in the RRC release or SI), and the UE (100) will check for this identity in paging DCI and/or paging early indication as explained later. Otherwise, the UE (100) considers that paging sub-group is not configured.

The paging-sub-group can be indicated by adding one or more paging-sub-group-id in the paging DCI. Below options (one or combination of) are proposed to indicate network configured/provided paging-sub-group through DCI-

1. Utilizing the reserved bits in the DCI format 1_0 (paging DCI) to indicate the network configured/provided paging-sub-group(s).

2. A new paging DCI is introduced to indicate the network configured/provided paging-sub-group(s).

3. Paging Early Indication (PEI)/WUS (Wake-Up signal) (e.g. new DCI based or other mechanism like introducing new low power consuming RF (Radio Frequency) sequence at UE) for idle/inactive mode UEs for paging reception. The paging early indication can carry UE paging-sub-group(s) indication for Idle/Inactive UEs.

Alternatively, an enhanced SSS/CSIRS/TRS/new DMRS like signal in the idle/the inactive state to indicate the presence of further paging DCI. These signals are provided at a configurable offset to the PO. Their presence and/or pattern indicate the presence or absence of paging message for one or more UEs (100). The UE (100), on reception of paging DCI, checks if the paging-sub-group-id received in paging DCI according to the configured paging-sub-group. If it is indicated according to the paging DCI and the configured paging-sub-group, the UE (100) proceeds for further paging message reception, else moves to sleep mode.

The method can be effectively used to avoid the false alarm by introducing the paging-sub-groups under each paging group. The wireless network (1000) may utilize ‘K’ paging-sub-group IDs for paging purpose over the given cell or paging coverage area. The number of paging-sub-group ‘K’ is indicated to the UE (100) in system information message on the cell e.g. SIB1. That is, paging-sub-group can be configured on the cell basis and thereby, different cells may configure different paging-sub-groups in order to meet the network load and varied demand for paging. When number of paging-sub-group is absent in the SI message (e.g. on SIB1 message), it implies the network (1000) has not deployed/supported paging reduction feature. Alternatively, number of paging-sub-group ‘K’ is pre-decided for the given release of the UE (100) e.g. specification would define the number of paging-sub-group for Release 17 UE and so on. The UE (100) calculates the PO and PF according to existing mechanism and reads paging DCI (DCI format 1_0 with CRC scrambled by P-RNTI). The paging DCI message indicates applicable paging-sub-group(s). The UEs (100) belonging to these sub-groups only read further paging message.

The legacy DCI format 1_0 for the P-RNTI is described below:

1. The following information is transmitted by means of the DCI format 1_0 with the CRC scrambled by the P-RNTI:

a) Short Messages Indicator—2 bits according to Table 7.3.1.2.1-1 for Short Message indicator [TS38.212].

b) Short Messages—8 bits, according to Clause 6.5 of [TS38.331]. If only the scheduling information for Paging is carried, this bit field is reserved.

c) Frequency domain resource assignment—bits. If only the short message is carried, this bit field is reserved.

d) is the size of CORESET

e) Time domain resource assignment—4 bits as defined in Clause 5.1.2.1 of [TS38.214]. If only the short message is carried, this bit field is reserved.

f) Virtual Resource Blocks to Physical Resource Block (VRB-to-PRB) mapping—1 bit according to Table 7.3.1.2.2-5 for VRB-to-PRB mapping [TS38.212]. If only the short message is carried, this bit field is reserved.

g) Modulation and coding scheme—5 bits as defined in Clause 5.1.3 of [TS38.214], using Table 5.1.3.1-1 for MCS index table 1 for PDSCH. If only the short message is carried, this bit field is reserved.

h) TB scaling—2 bits as defined in Clause 5.1.3.2 of [TS38.214]. If only the short message is carried, this bit field is reserved.

i) Reserved bits—8 bits for operation in a cell with shared spectrum channel access; otherwise 6 bits

In an embodiment, the reserved bits in the DCI format 1_0 can be conditionally used for indicating the paging-sub-group information field in a bitmap format. For example, one or more or all bits available in ‘Reserved bits’ field can be used. A bit when set to 1 represents presence of paging for a specific paging-sub-group and when set 0, it indicates absence of paging for the paging-sub-group. Alternatively, the pagingsub-grouping Id can also be represented by the bits together e.g. When using 4 bits, ‘0000’ indicates paging-sub-group 1, ‘0001’ indicates paging-sub-group 2 and so on. Further, the paging-sub-group information field is only interpreted by UEs (100) supporting paging reduction feature and otherwise, remain reserved. That is, Legacy UEs and Release 17 UEs, which do not support paging reduction feature, would ignore paging-sub-group information field in DCI format 1_0 and proceed for paging message reception as per legacy mechanism. Number of paging-sub-group(s) can be configurable parameter by the network (1000). The maximum number of pagingsub-group(s) supported is decided given the limited number of reserved bits in the DCI.

In an embodiment, consider introducing new information field indicating presence of paging message for only a sub-set of UEs (100) in the specific paging group (PO). The new field “paging-sub-group information” is introduced for the P-RNTI to indicate presence of paging message for specific paging-sub-group(s) in the bitmap format. In an example, bit 0 corresponds to first paging-sub-group, bit 1 corresponds to second paging-sub-group and so on. Alternatively, paging-sub-grouping ID can also be represented by the bits together e.g. When using 4 bits, ‘0000’ indicates paging-sub-group 1, ‘0001’ indicates paging-sub-group 2 and so on. Number of paging-sub-group(s) can be configurable parameter by the network (1000). The paging-sub-group information field can be defined within DCI format 1_0 or a new DCI format provided in paging PDCCH and/or PEI (Paging Early Indication)/WUS (Wake-up signal).

The UE (100) initiated RRC release (e.g. dataInactivitytimer expiry): In certain scenarios, there may be a mismatch in the RRC state at the UE (100) and the network (1000) e.g. when the UE (100) loses the RRC Release message. There can be many cause for this to happen, for example, the UE (100) is not able to decode the message due to poor signal conditions and/or UE (100) is engaged in multi-SIM operations and is engaged with higher priority task (e.g. paging reception) on the other SIM/Network etc. In such scenarios, state mismatch problem can be overcome by the UE (100) with the autonomously releasing of RRC connection. The UE (100) initiates the RRC release autonomously, for example, when dataInactivitytimer is expired when there is no reception or transmission of Medium access control Service Data Unit (MAC SDU) for the stipulated time duration provided by dataInactivitytimer. MAC layer informs higher layer i.e. RRC about dataInactivitytimer expiry and RRC undertakes RRC connection release i.e. it transits to RRC_IDLE state. In this case, with regard to paging-sub-group usage for the paging reception in idle mode, the proposed method can be used to:

1. Perform paging reception in idle mode with utilizing paging-sub-group as was received in the last RRC release; otherwise, if no RRC Release was received earlier, perform paging reception in the idle mode with utilizing default paging-sub-group (default paging-sub-group can be pre-defined or signaled in the SI)

2. Perform the paging reception in the idle mode with utilizing paging-sub-group as was received in the last RRC Release; otherwise, if no RRC Release was received earlier, perform paging reception in idle mode as in legacy i.e. no paging-sub-group is used.

3. Perform the paging reception in the idle mode with utilizing default pagingsub-group.

4. Perform the paging reception in the idle mode as in legacy i.e. no pagingsub-group is used.

5. The UE (100) determines its paging sub-group identity based on its UE ID (or based on paging probability or power consumption profile or based on UE ID/paging probability/power consumption profile/preferred network or RAN slice as indicated by network in SI or RRCRelease). Further, the UE (100) perform paging reception in idle mode using determined paging sub-group.

In the above various embodiments, the paging sub-group is used if camped cell and the UE (100) supports paging sub-group feature. The network (1000) can also indicate which alternative to use.

The data inactivity monitoring: The UE (100) may be configured by the RRC with a Data inactivity monitoring functionality, when in the RRC_CONNECTED. The RRC controls data inactivity operation by configuring the timer dataInactivityTimer. When dataInactivityTimer is configured, the UE (100) shall:
1. if any MAC entity receives a MAC SDU for DTCH logical channel, DCCH logical channel, or CCCH logical channel; or
2. if any MAC entity transmits a MAC SDU for DTCH logical channel, or DCCH logical channel -
a) start or restart dataInactivityTimer.
3. if the dataInactivityTimer expires:
a) indicate the expiry of the dataInactivityTimer to upper layers.

The UE actions upon the expiry of DataInactivityTimer: Upon receiving the expiry of DataInactivityTimer from lower layers while in RRC_CONNECTED, the UE (100) shall:
a) Perform the actions upon going to the RRC_IDLE as specified in 5.3.11, with release cause ‘RRC connection failure’.
b) Perform paging reception in idle mode with utilizing paging-sub-group as was received in last RRC Release; otherwise, if no RRC Release was received earlier, perform paging reception in the idle mode with utilizing default paging-sub-group.

Upon receiving the expiry of DataInactivityTimer from lower layers while in RRC_CONNECTED, the UE (100) shall:
a) Perform the actions upon going to RRC_IDLE as specified, with release cause ‘RRC connection failure’.
b) Perform paging reception in idle mode with utilizing paging-sub-group as was received in last RRC Release; otherwise, if no RRC Release was received earlier, perform paging reception in idle mode as in legacy i.e. no paging-sub-group is used.

TA/RAN update: When there is change in the TA/RAN Notification area, the UE (100) performs the TA/RAN update and informs the assistance information that includes at least one of power consumption status (e.g. high, low, medium) or power consumption profile (e.g. with N levels), mobility status (e.g. stationary, low mobility, high mobility, etc.), location, power saving preference, current paging-sub-group, preferred network or RAN slice etc. to the network (1000). The assistance information can be used by network (1000) to assign paging sub-group identity to the UE (100). The assistance information can be included in the NAS message or the RRC message (e.g. UE assistance information message or UE capability information message).

To bring in dynamism, additional update on the UE status (mobility, power consumption status, location, power saving preference etc.) can be added in TA/RAN update or UE assistance information so that the UE paging-sub-group can be updated by the network (1000). However, it may make it a bit complex with a lot of signaling information and moreover paging-sub-group operation is Network controlled. Therefore, it is proposed that the network specify (e.g. in RRC Reconfiguration message or RRC release message or SI) to the UE (100) as to what exactly be informed additionally in the TA/RAN update or UE assistance information e.g. the network (1000) can specify at least one of mobility, power consumption status, location, power saving preference etc.

Signaling selection for paging-sub-group determination by the network (1000): The UE location (e.g., Cell/TA/RA), power consumption sensitivity or power consumption profile, UE power saving preference, mobility, Release version, paging probability, network load per cell/TA/RA, single/dual/multi-SIM operation of the UE (100), preferred network or RAN slice etc., is used by the network (1000) while determining the paging-sub-group for the UE (100) and then, indicating the same for the UE (100) when it is transitioned to idle and/or inactive mode.

In another embodiment, paging retransmission indication: paging message carries the paging retransmission indication. The paging retransmission indication is provided or is set to TRUE when the network (1000) undertakes another (second or later) paging attempt when the UE (100) has not responded to the paging. As there can be multiple reasons because of which the UE (100) may not have responded e.g. the UE (100) has moved out of paging coverage area and therefore next paging attempt should be extended in coverage area or UE (100) is not able to decode the paging message due to poor signaling conditions or the UE (100) is dual/multi SIM device and is engaged on a second/other SIM/Network when paging was transmitted on first SIM/Network and thereby, lost paging message.

Consequently, all the UEs which have received paging message in previous attempt and/or have not moved to another cell/coverage area and/or was not engaged with dual/multi-SIM gap or operation can avoid handling the paging message which has paging retransmission indication set as TRUE. Effectively, these UEs (100) will not receive and/or process the paging PDSCH and thereby, avoids false alarm for the paging. Retransmission indication can be considered per paging sub-group so that new transmission and retransmission of different groups can be sent together in same paging message.
1. The UE (100) receives paging message at time T1
2. The UE (100) receives paging message at time T2. (T2>T1)
3. There can be several DRX cycles between T1 and T2. Even DRX cycles can be different amongst the UEs. To address this, further, one of many options can be utilized additionally.
a) Some additional info e.g. LSBs of SFN ID, SFN, SN, etc. is provided or
b) If paging retransmission indication is set to T and UE (100) has already received a paging message in immediately previous DRX cycle, UE (100) ignores this paging message, or
c) If paging retransmission indication is set to T and UE has already received a paging message in immediately previous default DRX cycle, the UE (100) ignores this paging message.

In another embodiment, the paging operation for the UE (100) is determined by the network (1000) with utilizing one or more Power consumption sensitivity (PCS) or power consumption profile, paging probability and UE_ID. Multiple PCS levels are defined e.g. based on UE battery threshold levels and/or when it is not connected to power supply and/or it is different mobility status (e.g. high/medium/low/static mobility) and/or based on signal conditions and/or based on location of UE (cell edge or closer to cell center) and/or depending on rate of measurement/reselections operations. Based on PCS levels, UEs (100) are grouped together between different paging-sub-groups for the paging purpose. For the UEs (100) which are highly sensitive to power consumption (i.e. higher PCS), the false alarm rate for paging should be kept less to conserve power.

The paging probability determines how often the UE (100) would be paged e.g. the UE (100) may be paged with higher probability given it has subscribed to frequently used service or more number of services. In the UE_ID based paging sub-group identity determination approach, the UEs (100) are grouped among different paging sub-groups based on their UE_ID only e.g. the UE (100) determines its pagingsub-group as

paging_sub_group ID=floor (UE_ID/(N*Ns)) mod Nps

Where Nps—Number of paging-sub-groups as configured by the network (1000) as proposed by current invention. The UE Identity is based on 5G-S-TMSI e.g. 5G-S-TMSI mod 1024, 5G-S-TMSI mod 8192 or in general, 5G-S-TMSI mod X, wherein X is (1024*Nps).

However, there can be high PCS UEs with different paging probability, therefore, grouping UEs based on only one criteria like PCS may not reduce false alarm rate.

In another embodiment, a combined approach is proposed and UEs (100) are grouped as follows:

1. Paging-sub-group from 1 to N−X−Y: All the UEs (100) which are not having high PCS or high paging probability.

2. Paging-sub-group from N−X−Y+1 to N−Y: All the UEs (100) which are having high PCS but not high paging probability.

3. Paging-sub-group from N−Y+1 to N: All the UEs (100) which are having high paging probability.

In an embodiment, the paging sub-group information wherein sub-group is based on paging probability (or UE ID) can be indicated on paging DCI and/or early paging indication. Additionally, paging DCI and/or paging early indication includes indication about PCS levels. For example, if there are two PCS level high and low, two bits can be there in paging DCI, one bit for high PCS level and 1 bit for low PCS level. High PCS level bit is set to 1, if paging message includes paging for UE(s) (100) with high PCS level. Low PCS level bit is set to 1, if paging message includes paging for UE(s) (100) with low PCS level. Both bits can also be set to 1 in same DCI. Upon receiving paging DCI and/or early paging indication, the UE (100) first checks whether the bit corresponding to its PCS level is set or not. If set to 1, the UE (100) further checks whether bit corresponding to its sub-group is set to 1 or not. If set to 1, the UE (100) receives the paging message.

Depending on the network load and/or UE mobility and/or UE assistance information for the power saving preference, power consumption status, paging probability, the UE location etc., and network can decide to transition the paging operation from pagingsub-group to legacy paging and vice-versa. This transition can be done by updating the paging sub-group information in SI.

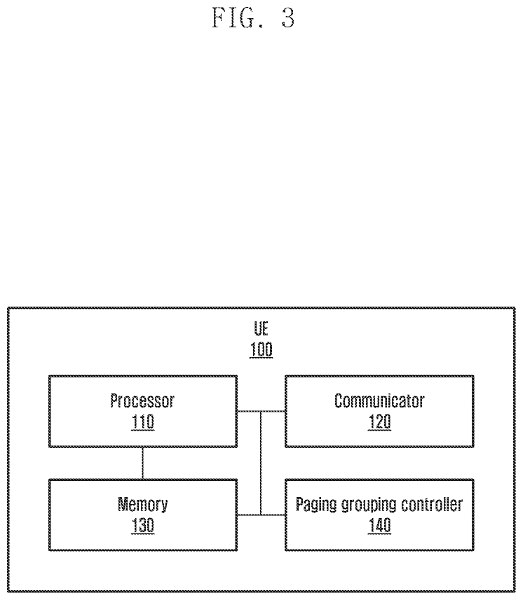

FIG. 3 shows various hardware components of the UE (100), according to an embodiment as disclosed herein. In an embodiment, the UE (100) includes a processor (110), a communicator (120), a memory (130) and a paging grouping controller (140). The processor (110) is coupled with the communicator (120), the memory (130), and the paging grouping controller (140).

The paging grouping controller (140) is configured to receive the NAS message from the AMF entity (300) carrying paging sub-group identity for the UE (100) (based on the core network controlled sub-grouping method) or the SIB message from the gNodeb (200) (UE Id based sub-grouping method). Further, the paging grouping controller (140) is configured to determine whether the SIB message includes the paging sub-group configuration having the number of paging sub-groups or the offset for the PEI indicating the presence or absence of the paging sub-group identity. If the RRC message includes the paging sub-group configuration having the number of paging sub-groups then, the paging grouping controller (140) configures the UE (100) to determine the paging sub-group identity based on formulation based on UE identity. Paging sub-group identity is given by paging_sub_group ID=floor (UE_ID/(N*Ns)) mod Nps, where Nps−Number of paging-sub-groups as configured by the network (1000) in the cell as proposed by current invention. UE Identity is based on 5G-S-TMSI e.g. 5G-S-TMSI mod 1024, 5G-S-TMSI mod 8192 or in general, 5G-S-TMSI mod X, wherein X is (1024*Nps). If the SIB message does not include the paging sub-group configuration having the number of paging sub-groups or number of paging sub-groups is 0 or number of paging sub-groups is 1 then, the paging grouping controller (140) is configured to determine that the UE identity based paging subgrouping is not applied.

Further, the paging grouping controller (140) is configured to determine the PEI based on the offset. Further, the paging grouping controller (140) is configured to receive the indication indicating support for the paging sub-group identity from the cell on which the UE (100) is currently camped, where the indication includes the paging sub-group related parameter (e.g. number of paging sub-groups per PO). Based on receiving, the paging grouping controller (140) is configured to receive the at least one of paging DCI, the PEI, and the reference signal to indicate the presence or absence of the paging for UE's sub-group identity in the paging occasion from the AMF entity (300) or the gNodeb (200). Further, the paging grouping controller (140) is configured to detect whether availability of the sub-group identity in the at least one of paging DCI, the PEI, and the reference signal. In response to detecting the presence of the subgroup identity in the at least one of paging DCI, the paging early indication and the reference signal, the paging grouping controller (140) is configured to perform the paging reception using the paging sub-group identity. In another embodiment, the paging grouping controller (140) configures the UE (100) in a sleep mode in response to detecting absence of the sub-group identity in the at least one of the paging DCI, the paging early indication and the reference signal.

The paging grouping controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) stores information about the gNodeb (200) and the AMF entity (300). The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

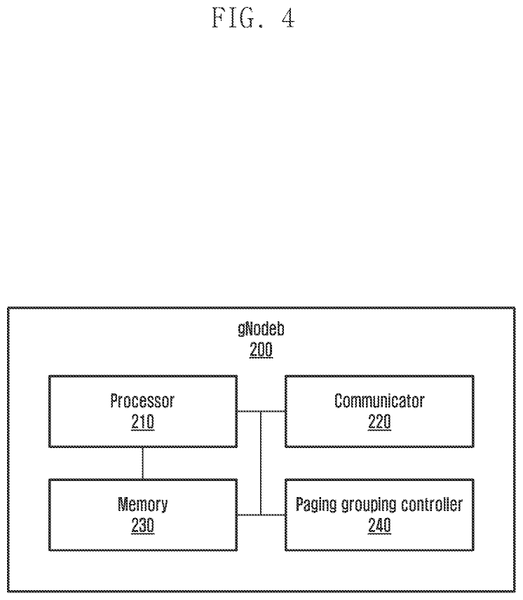

FIG. 4 shows various hardware components of the gNodeb (200), according to an embodiment as disclosed herein. In an embodiment, the gNodeb (200) includes a processor (210), a communicator (220), a memory (230) and a paging grouping controller (240). The processor (210) is coupled with the communicator (220), the memory (230), and the paging grouping controller (240).

The paging grouping controller (240) is configured to determine paging sub-group information to be allocated to the UE (100) based on the identity of the UE (100) and the total number of sub-groups associated with the UE identity based-sub-grouping in the cell. Further, the paging grouping controller (240) is configured to allocate the paging sub-group information to the UE (100) for paging. In an embodiment, the paging sub-group information is allocated to the UE (100) by sending the SIB message comprising the paging sub-group configuration to the UE (100).

Further, the paging grouping controller (240) is configured to determine the total number of sub-groups for the UE identity based-sub-grouping for each cell, wherein total number of sub-groups for the UE identity based-sub-grouping is different in different cells. The paging grouping controller (240) is configured to broadcast the total number of sub-groups in a system information to the UE (100).

Further, the paging grouping controller (240) is configured to determine an offset to indicate a presence of a paging DCI and send the offset along with the paging subgroup information to the UE (100).

The paging grouping controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) stores information about the UE (100) and the AMF entity (300). The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 4 shows various hardware components of the gNodeb (200) but it is to be understood that other embodiments are not limited thereon. In other embodiment, the gNodeb (200) may include less or more number of components. Further, the labels or names of the components are used only for illustrative purpose and does not limit the scope of the invention. One or more components can be combined together to perform same or substantially similar function in the gNodeb (200).

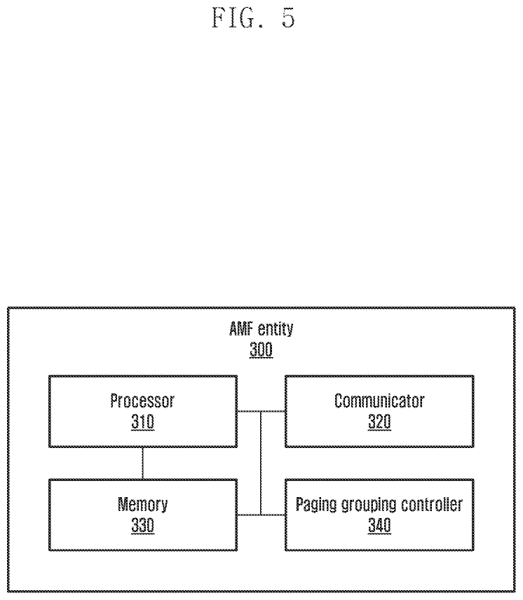

FIG. 5 shows various hardware components of the AMF entity (300), according to an embodiment as disclosed herein. In an embodiment, the AMF entity (300) includes a processor (310), a communicator (320), a memory (330) and a paging grouping controller (340). The processor (310) is coupled with the communicator (320), the memory (330), and the paging grouping controller (340).

The paging grouping controller (340) is configured to determine the paging subgroup information to be allocated to the UE (100) based on at least one of the characteristics of the UE (100). In an embodiment, the paging grouping controller (340) is configured to receive the assistance information from the UE (100). The assistance information includes the power consumption sensitivity (PCS) or power consumption profile and the paging probability information. Further, the paging grouping controller (340) is configured to determine the paging sub-group information to be allocated to the UE (100) based on at least one of the characteristics of the UE (100) and the assistance information received the UE (100).

Further, the paging grouping controller (340) is configured to allocate the paging sub-group information to the UE (100) for paging. In an embodiment, the paging grouping controller (340) is configured to send the NAS message including the paging sub-group identity to the UE (100). In another embodiment, the paging grouping controller (340) is configured to send the sub-group information (e.g. paging sub-group identity allocated to UE) to the gNodeb (200) associated with the UE (100) and allocate the paging sub-group information (e.g. paging sub-group identity) to the UE (100) for paging.

The paging grouping controller (340) is configured to send the allocated paging subgroup identity to the UE (100) and the gNodeb (200). Further, the paging grouping controller (340) is configured to send the NAS signaling message comprising the allocated paging sub-group information allocated to the UE (100) and the gNodeb (200).

The paging grouping controller (340) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (310) is configured to execute instructions stored in the memory (330) and to perform various processes. The communicator (320) is configured for communicating internally between internal hardware components and with external devices via one or more networks. The memory (330) stores information about the gNodeb (200) and the UE (100. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

Although the FIG. 5 shows various hardware components of the AMF entity (300) but it is to be understood that other embodiments are not limited thereon. In other embodiments, the AMF entity (300) may include less or more number of components. Further, the labels or names of the components are used only for illustrative purpose and does not limit the scope of the invention. One or more components can be combined together to perform same or substantially similar function in the AMF entity (300).

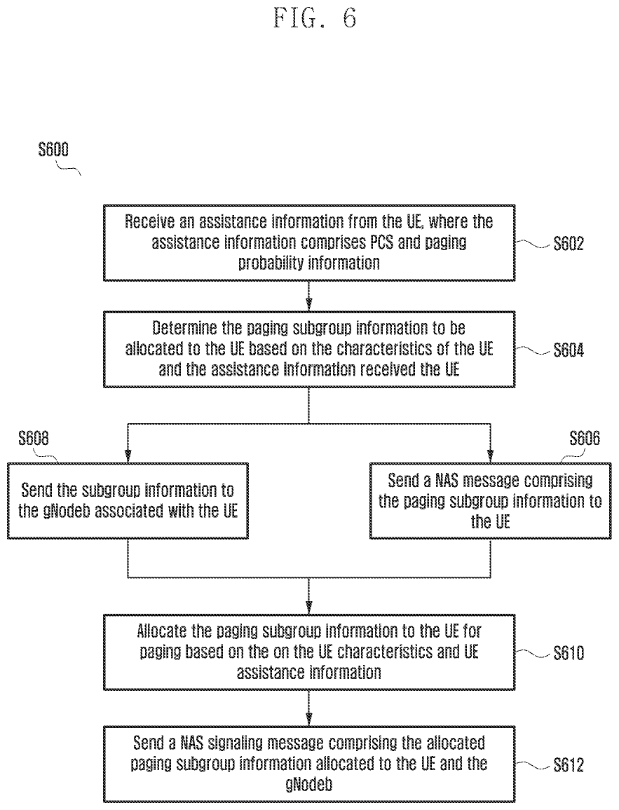

FIG. 6 is a flow chart (S600) illustrating a method, implemented by the AMF entity (300), for grouping of paging for multiple UEs in the paging occasion in the wireless network (1000), according to an embodiment as disclosed herein. The operations (S602-S618) are handled by the paging grouping controller (340).

At S602, the method includes receiving the assistance information from the UE (100), where the assistance information comprises the PCS and paging probability information. At S604, the method includes determining the paging sub-group information to be allocated to the UE (100) based on at least one of the characteristics of the UE (100) and the assistance information received from the UE (100). At S606, the method includes sending the NAS message the paging sub-group information (e.g. paging sub-group identity) to the UE (100).

At S608, the method includes sending the sub-group information to the gNodeb (200) associated with the UE (100). At S610, the method includes allocating the paging sub-group information to the UE (100) for paging based on the at least one of the UE characteristics and UE assistance information.

At S612, the method includes sending the NAS signaling message comprising the allocated paging sub-group information allocated to the UE (100) and the gNodeb (200).

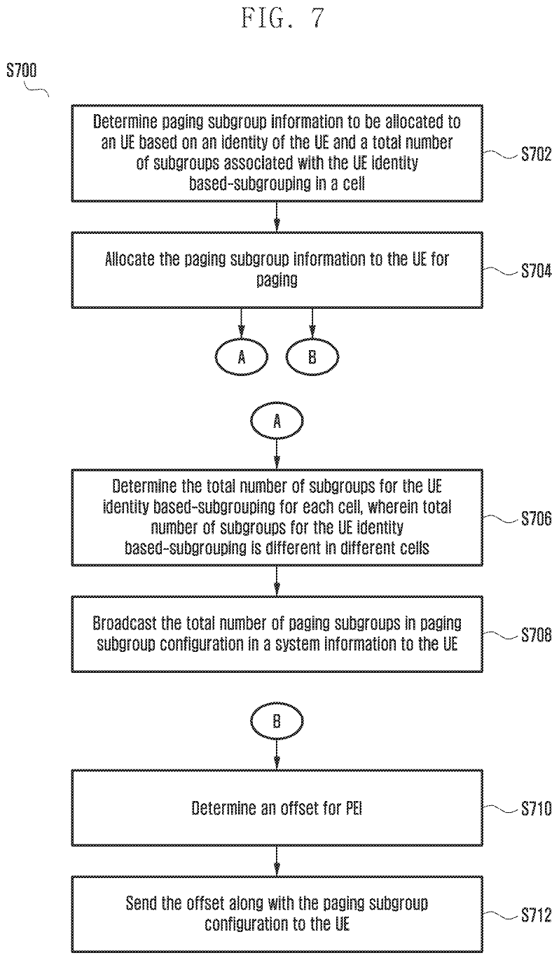

FIG. 7 is a flow chart (S700) illustrating a method, implemented by the gNodeb (200), for grouping of paging for multiple UEs in the paging occasion in the wireless network (1000), according to an embodiment as disclosed herein. The operations (S702-S712) are handled by the paging grouping controller (240).

At S702, the UE ID based sub-grouping method includes determining the paging sub-group information to be allocated to the UE (100) based on the identity of the UE (100) and the total number of sub-groups associated with the UE identity basedsub-grouping in the cell. At S704, the method includes allocating the paging sub-group information to the UE (100) for paging. At S706, the method includes determining the total number of sub-groups for the UE identity based-sub-grouping for each cell, where the total number of sub-groups for the UE identity based-sub-grouping can be different in different cells.

At S708, the method includes broadcasting the total number of paging sub-groups in the paging sub-group configuration in the system information to the UE (100). At S710, the method includes determining the offset for PEI. At S712, the method includes sending the PEI configuration having offset parameter along with the paging sub-group configuration to the UE (100). One possible structure for paging sub-group configuration to be sent in SIB is shown as follows:

| Sub-groupConfig-r17 ::= | SEQUENCE { | |
|---|---|---|
| sub-groupsNumPerPO-r17 | | INTEGER (1.. maxNroPagingSub-groups-r17), |
| sub-groupsNumforUEID-r17 | | INTEGER (1.. maxNroPagingSub-groups-r17) |
| ... | | |
| } | | |

Where sub-groupNumPerPO is the total number of sub-groups per paging occasion for the UE (100). sub-groupNumforUEID is the number of sub-groups per paging occasion for the UE (100) for UEID-based sub-group approach. MaxNroPagingSubgroups is the maximum number of paging sub-groups per paging occasion and this can be specified as 8.

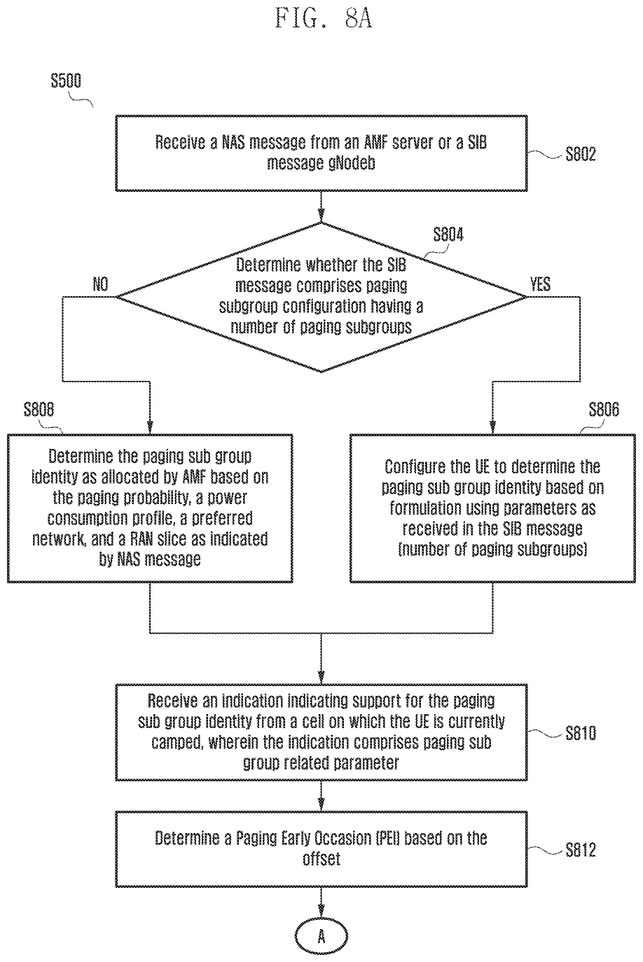

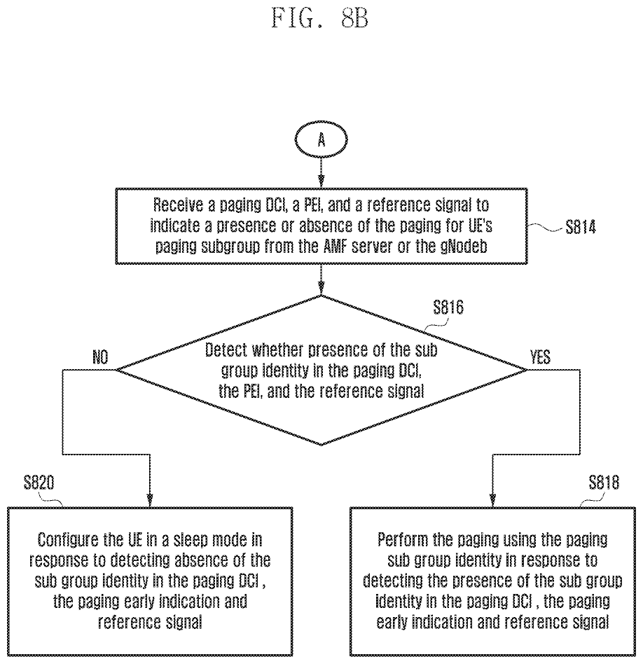

FIG. 8A and FIG. 8B are a flow chart (S800) illustrating a method, implemented by the UE (100), for grouping of paging for multiple UEs in the paging occasion in the wireless network (1000), according to an embodiment as disclosed herein. The operations (S802-S820) are handled by the paging grouping controller (140).

At S802, the method includes receiving the NAS message from the AMF entity (300) carrying paging sub-group identity allocated to UE or the SIB message from gNodeb (200). At S804, the method includes determining whether the SIB message comprises the paging sub-group configuration having the number of paging sub-groups or the offset for the PEI indicating the presence or absence of the UE's paging sub-group identity in the paging occasion. If the SIB message comprises the paging sub-group configuration having the number of paging sub-groups or the offset for PEI indicating the presence or absence of the UE's paging sub-group identity in the paging occasion then, at S806, the method includes configuring the UE (100) to determine the paging sub-group identity using formulation based on identity of the UE and parameters as received in the SIB message i.e. number of paging sub-groups. Paging sub-group identity is given by paging_sub_group ID=floor (UE_ID/(N*Ns)) mod Nps, where Nps−Number of paging-sub-groups as configured by the network (1000) in the cell as proposed by current invention. UE Identity is based on 5G-S-TMSI e.g. 5G-S-TMSI mod 1024, 5G-S-TMSI mod 8192 or in general, 5G-S-TMSI mod X, wherein X is (1024*Nps). If the SIB message does not comprise the paging sub-group configuration having the number of paging sub-groups or the offset for PEI indicating the presence or absence of the UE's paging sub-group identity in the paging occasion then, at S808, the method includes determining that UE ID based Paging sub-grouping approach is not applied. If NAS message is received carrying paging sub sub-group identity then, at S808, the method includes determining the paging sub-group identity as allocated by AMF based on the paging probability, a power consumption profile, a preferred network, and a RAN slice as indicated by NAS message.

At S810, the method includes receiving the indication indicating support for the paging sub-group identity from the cell on which the UE (100) is currently camped, where the indication comprises paging sub-group related parameter. At S812, the method includes determining the PEI based on the offset. At S814, the method includes receiving the paging DCI, the PEI, and the reference signal to indicate the presence or absence of the UE's paging sub-group identity in the paging occasion from the AMF entity (300) or the gNodeb (200). At S816, the method includes detecting whether availability of the sub-group identity in the paging DCI, the PEI, and the particular signal. At S818, the method includes performing the paging using the paging sub-group identity in response to detecting the presence of the sub-group identity in at least one of the paging DCI, the paging early indication and the reference signal. At S820, the method includes configuring the UE (100) in the sleep mode in response to detecting absence of the sub-group identity in the at least one of the paging DCI, the paging early indication and the reference signal.

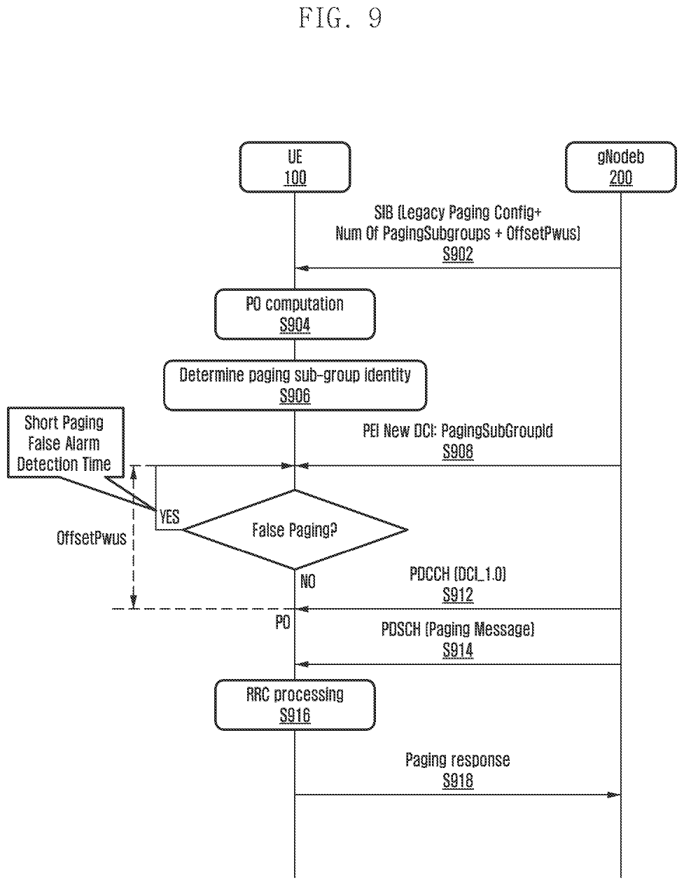

FIG. 9 is a sequence diagram illustrating a method for grouping of paging in the wireless network (1000) based on the UE ID based paging sub-group, according to an embodiment as disclosed herein.

At S902, the gNodeb (200) sends the SIB (including legacy paging Config+Num of Paging Sub-groups+OffsetPwus) to the UE (100). The UE (100) receives the SIB. At S904, the UE (100) performs the PO computation. At S906, the UE (100) determines the paging sub-group identity. At S908, the UE (100) receives the PEI New DCI: PagingSub-groupId from the gNodeb (200). At S910, the UE (100) determines the false paging is detected based on the PEI new DCI? If the false paging is not detected then, at S912, the UE (100) receives the PDCCH (DCI_1.0) from the gNodeb (200). If the false paging is detected then, the method performs the operation S908. At S914, the UE (100) receives the PDSCH (i.e., paging message) from the gNodeb (200). At S916, the UE (100) processes the RRC. At S918, the UE (100) sends the paging response to the gNodeb (200).

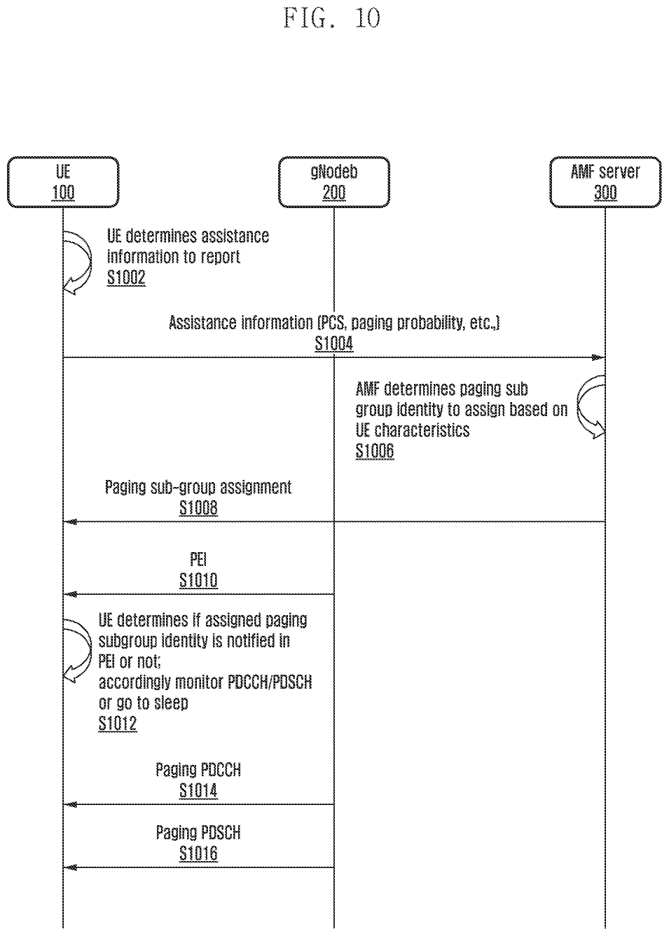

FIG. 10 is a sequence diagram illustrating a method for grouping of paging in the wireless network (1000) based on the NAS signaling for assistance information, according to an embodiment as disclosed herein. At S1002, the UE (100) determines the assistance information (e.g., PCS, paging probability, etc.,) to report. At S1004, the UE (100) sends the assistance information to the AMF entity (300). At S1006, the AMF entity (300) determines the paging sub-group identity to assign based on at least one of the UE characteristics. At S1008, the AMF entity (300) sends the paging subgroup assignment to the UE (100). At S1010, the gNodeb (200) sends the PEI to the UE (100). At S1012, the UE (100) determines if the assigned paging sub-group identity is notified in the PEI or not and accordingly, the UE (100) monitors the PDCCH/PDSCH or go to the sleep mode. At S1014, the gNodeb (200) sends the paging PDCCH to the UE (100). At S1016, the gNodeb (200) sends the paging PDSCH to the UE (100).

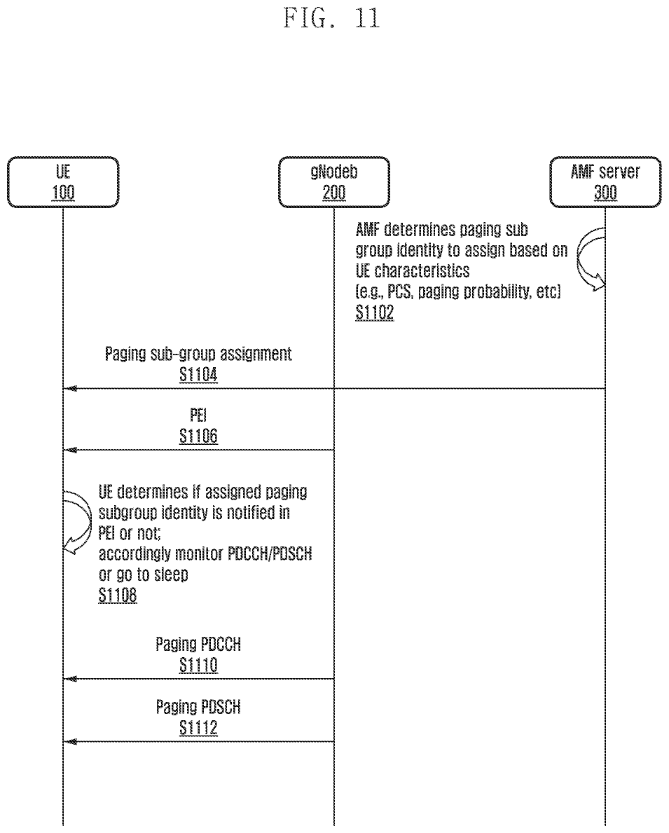

FIG. 11 is a sequence diagram illustrating a method for grouping of paging in the wireless network (1000) without any assistance information from the UE (100), according to an embodiment as disclosed herein.

At S1102, the AMF entity (300) determines the paging sub-group to assign based on the UE characteristics. At S1104, the AMF entity (300) sends the paging sub-group identity assignment to the UE (100). At S1106, the gNodeb (200) sends the PEI to the UE (100). At S1108, the UE (100) determines if the assigned paging sub-group identity is notified in the PEI or not and accordingly, the UE (100) monitors the PDCCH/PDSCH or go to the sleep mode. At S1110, the gNodeb (200) sends the paging PDCCH to the UE (100). At S1112, the gNodeb (200) sends the paging PDSCH to the UE (100).

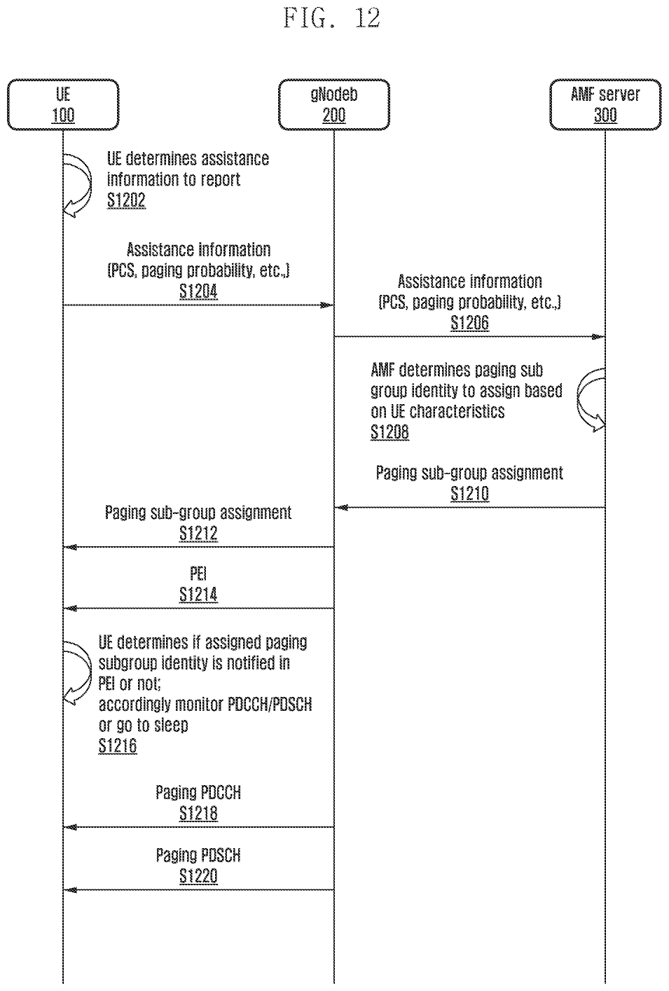

FIG. 12 is a sequence diagram illustrating a method for grouping of paging in the wireless network (1000) based on a RRC signaling based assistance information, according to an embodiment as disclosed herein. At S1202, the UE (100) determines the assistance information (e.g., PCS, paging probability, etc.,) to report. At S1204, the UE (100) sends the assistance information to the gNodeb (200). At S1206, the gNodeb (200) sends the assistance information to the AMF entity (300). At S1208, the AMF entity (300) determines the paging sub-group identity to assign based on the UE characteristics. At S1210, the AMF entity (300) sends the paging sub-group assignment to the gNodeb (200). At S1212, the gNodeb (200) sends the paging sub-group assignment to the UE (100). At S1214, the gNodeb (200) sends the PEI to the UE (100). At S1216, the UE (100) determines if the assigned paging sub-group identity is notified in the PEI or not and accordingly, the UE (100) monitors the PDCCH/PDSCH or go to the sleep mode. At S1218, the gNodeb (200) sends the paging PDCCH to the UE (100). At S1220, the gNodeb (200) sends the paging PDSCH to the UE (100).

The various actions, acts, blocks, steps, or the like in the flow charts (S600-S800) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a base station in a wireless network, wherein the method comprises:
determining a number of subgroups for a user equipment (UE) identity (ID) based subgrouping in a cell;
broadcasting system information including the number of subgroups for UE ID;
determining paging sub-group identity based on the number and the UE ID; and
performing a paging transmission based on the determined paging sub-group identity.

17. The method as claimed in claim 16, further comprising:
transmitting, to the UE, a paging early indication (PEI).

18. The method as claimed in claim 16, wherein the paging subgroup identity is transmitted from an access and mobility management function (AMF) entity to the UE, via non-access-stratum (NAS) signalling.

19. The method as claimed in claim 16, wherein different cells configure different paging-sub-group.

20. A method performed by a user equipment (UE) in a wireless network, wherein the method comprises:
receiving, from a by a base station, system information including a number of subgroups for a UE identity (ID) based subgrouping in a cell;
determining paging sub-group identity based on the number and the UE ID; and
performing a paging reception based on the determined paging sub-group identity.

21. The method as claimed in claim 20, further comprising:
receiving, from the base station, a paging early indication (PEI).

22. The method as claimed in claim 20, further comprising:
receiving, from an access and mobility management function (AMF) entity, the paging sub-group identity via non-access-stratum (NAS) signalling.

23. The method as claimed in claim 20, wherein different cells configure different paging-sub-group.

24. A base station in a wireless network, wherein the base station comprises:
a memory;
a processor; and
the processor configured to:
determine a number of subgroups for a user equipment (UE) identity (ID) based subgrouping in a cell,
broadcast system information including the number of subgroups for UE ID,
determine paging sub-group identity based on the number and the UE ID, and
perform a paging transmission based on the determined paging subgroup identity.

25. The base station as claimed in claim 24, wherein the processor is further configured to transmit, to the UE, a paging early indication (PEI).

26. The base station as claimed in claim 24, wherein the paging subgroup identity is transmitted from an access and mobility management function (AMF) entity to the UE, via non-access-stratum (NAS) signalling.

27. The base station as claimed in claim 24, wherein different cells configure different paging-sub-group.

28. A User Equipment (UE) for grouping of paging in a wireless network, wherein the UE comprises:
a memory to store information about a next generation Node B (gNodeb) and an access and mobility management function (AMF) entity;
a processor; and
the processor configured to:
receive, from a by a base station, system information including a number of subgroups for a UE identity (ID) based subgrouping in a cell,
determine paging sub-group identity based on the number and the UE ID, and
perform a paging reception based on the determined paging sub-group identity.

29. The UE as claimed in claim 28, wherein the processor is further configured to receive, from the base station, a paging early indication (PEI).

30. The UE as claimed in claim 28, wherein the processor is further configured to receive, from the AMF entity, the paging sub-group identity via nonaccess-stratum (NAS) signalling.
